(19) United States
(12) Patent Application Publication
(10) Pub. No.: US 2026/0331726 A1
(43) Pub. Date: Oct. 22, 2026

(54) TRACTION BATTERY PACK SENSOR ASSEMBLY AND SENSOR PROVIDING METHOD

(71) Applicant: Ford Global Technologies, LLC, Dearborn, MI (US)

(72) Inventors: Liam Faecke, Detroit, MI (US); Marc Bronzetti, Berkley, MI (US)

(21) Appl. No.: 19/181,413

(22) Filed: Apr. 17, 2025

(51) Int. Cl. H01M 50/569; H01M 50/211; H01M 50/249; H01M 50/528

(52) U.S. Cl. CPC H01M 50/569; H01M 50/211; H01M 50/249; H01M 50/528; H01M 2220/20

(57) ABSTRACT

A battery pack assembly includes a sensor tab configured to be secured to a component of a traction battery pack and a stranded wire. The stranded wire has a compressed portion providing the sensor tab and an uncompressed portion providing a sense lead extending from the sensor tab.

### TECHNICAL FIELD

This disclosure relates generally to a sensor assembly for a traction battery pack and, more particularly, to a sensor assembly having a compressed sensor tab and a sense lead that is stranded wire.

### BACKGROUND

Electrified vehicles include a traction battery pack for powering electric machines and other electrical loads of the vehicle. The traction battery pack can include a plurality of battery cells and various other battery internal components that support electric vehicle propulsion. Sensor assemblies can be utilized to monitor various parameters associated with the traction battery pack.

### SUMMARY

In some aspects, the techniques described herein relate to a battery pack assembly, including: a sensor tab configured to be secured to a component of a traction battery pack; and a stranded wire having a compressed portion that provides a sensor tab and an uncompressed portion that provides a sense lead extending from the sensor tab.

In some aspects, the techniques described herein relate to a battery pack assembly, wherein the sensor tab is an ultrasonically compressed sensor tab.

In some aspects, the techniques described herein relate to a battery pack assembly, wherein the sensor tab is provided by ultrasonically compressed stranded wire.

In some aspects, the techniques described herein relate to a battery pack assembly, wherein the sensor tab is secured to the component with at least one weld.

In some aspects, the techniques described herein relate to a battery pack assembly, wherein the at least one weld is at least one laser weld.

In some aspects, the techniques described herein relate to a battery pack assembly, wherein the component is a tab terminal of a battery cell.

In some aspects, the techniques described herein relate to a battery pack assembly, further including a control module, the sense lead extending from the sensor tab to a connector that connects to the control module.

In some aspects, the techniques described herein relate to a battery pack assembly, wherein the control module is a Battery Pack Sensor Module.

In some aspects, the techniques described herein relate to a battery pack assembly, wherein the stranded wire providing the sense lead includes a plurality of individual strands.

In some aspects, the techniques described herein relate to a battery pack assembly including: a cell stack including a plurality of battery cells disposed along a cell stack axis; a compressed sensor tab attached to a portion of at least one of the battery cells within the plurality of battery cells; and a stranded wire extending from the compressed sensor tab to a connector.

In some aspects, the techniques described herein relate to a battery pack assembly, wherein the portion is a tab terminal of at least one of the battery cells within the plurality of battery cells.

In some aspects, the techniques described herein relate to a battery pack assembly, wherein the compressed sensor tab is welded to at least one of the battery cells within the plurality of battery cells.

In some aspects, the techniques described herein relate to a battery pack assembly, further including a connector, the stranded wire extending from the compressed sensor tab to the connector, the connector configured to engage a Battery Pack Sensor Module.

In some aspects, the techniques described herein relate to a battery pack assembly, wherein the compressed sensor tab is provided by an ultrasonically compressed region of the stranded wire.

In some aspects, the techniques described herein relate to a battery pack assembly, further including an insulative coating, the stranded wire including a plurality of individual conductive strands bundled within the insulative coating.

In some aspects, the techniques described herein relate to a battery pack sensor providing method, including: sensing a parameter of a component within a traction battery pack through a sensor tab that is attached to the component, the sensor tab provided by a compressed region of a stranded wire.

In some aspects, the techniques described herein relate to a battery pack sensor providing method, further including attaching the sensor tab to the component by welding the sensor tab to the component.

In some aspects, the techniques described herein relate to a battery pack sensor providing method, further including, prior to the sensing and the attaching, compressing a portion of the stranded wire to provide the compressed region of the stranded wire.

In some aspects, the techniques described herein relate to a battery pack sensor providing method, wherein the compressing is an ultrasonic compressing.

In some aspects, the techniques described herein relate to a battery pack sensor providing method, further including, during the sensing, communicating data from the sensor tab through the stranded wire to a control module of the traction battery pack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates an expanded view of the battery pack from FIG. 1.

FIG. 3 illustrates a close-up view of an area of FIG. 2 showing a sensor assembly having a sense lead with a sensor tab secured to a component of the traction battery pack.

FIG. 4 illustrates a perspective view of a battery cell from the battery pack of FIG. 2.

FIG. 5 illustrates a sensor assembly form the battery pack of FIG. 2.

FIG. 6 illustrates a section view taken at line 6-6 in FIG. 5.

### DETAILED DESCRIPTION

This disclosure details exemplary sensor assemblies for a traction battery pack. The sensor assemblies can incorporate sense leads having a stranded wire and a sensor tab, which is provided by a compressed area of the stranded wire. After compressing a region of the stranded wire to establish the compressed area, no attachment of a sense lead to a sensor tab is required.

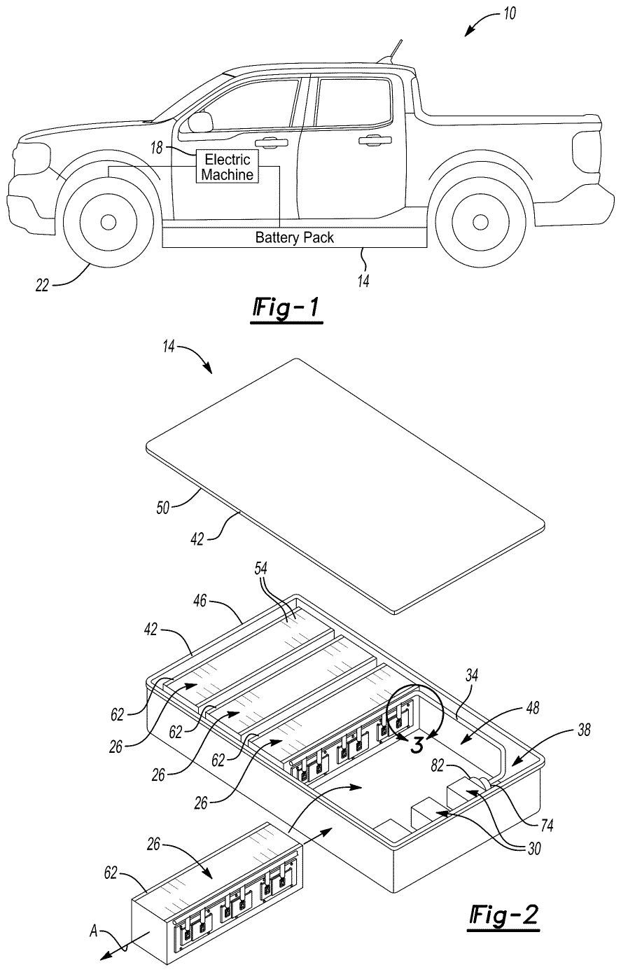

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

With reference now to FIGS. 2-4, the traction battery pack 14 includes, in the exemplary embodiment, a plurality of a cell stacks 26, control modules 30, sensor assemblies 34, and other battery pack components held within an interior 38 of an enclosure assembly 42. In this example, an enclosure tray 46 and an enclosure cover 50 are joined together to provide the interior 38.

Each of the cell stack 26 includes a plurality of individual battery cells 54 disposed along a respective cell stack axis A. The battery cells 54 store and supply electrical power for powering various components of the electrified vehicle 10.

In the exemplary embodiment, the battery cells 54 are lithium-ion pouch-style battery cells. However, battery cells having other geometries (cylindrical, prismatic, etc.) and/or chemistries (nickel-metal hydride, lead-acid, etc.) could alternatively be used within the scope of this disclosure.

The battery cells 54 each include tab terminals 58 extending from a case 60. Within the cell stack 26, the tab terminals 58 extend through a side frame 62 and are folded over- and attached to-a respective busbar 64. The side frames 62 hold the busbars 64. The tab terminals 58 can be attached to the busbars 64 with welds.

In this example, the sensor assemblies 34 are attached to respective tab terminals 58. The sensor assemblies 34 operatively connect the tab terminals 58 to one of the control modules 30. The sensor assemblies 34 can collect voltage information from the associated tab terminal 58. The voltage information is transmitted as a signal to the control module 30, which then monitors the voltages for battery cells 54 within the battery pack 14.

In another example, the sensor assemblies 34 could collect information other than voltage information. For example, the sensor assemblies 34 could collect temperature information and transmit that temperature information back to the control module 30.

Further, the sensor assemblies 34 could connect to components other than the tab terminals 58. The sensor assemblies 34 could be attached to the case 60 of one of the battery cells 54, or to a busbar, or some other component of the battery pack 14.

Thus, although the example sensor assemblies 34 are described as being operably connected to tab terminals 58 and being used to monitor voltage, the sensor assemblies 34, in other examples, could operably connect to any other component of the battery pack 14 and could be used to monitor various other parameters (e.g., temperature, current, state of charge, state of power, resistance, gas or pressure levels, humidity, vibration, etc.).

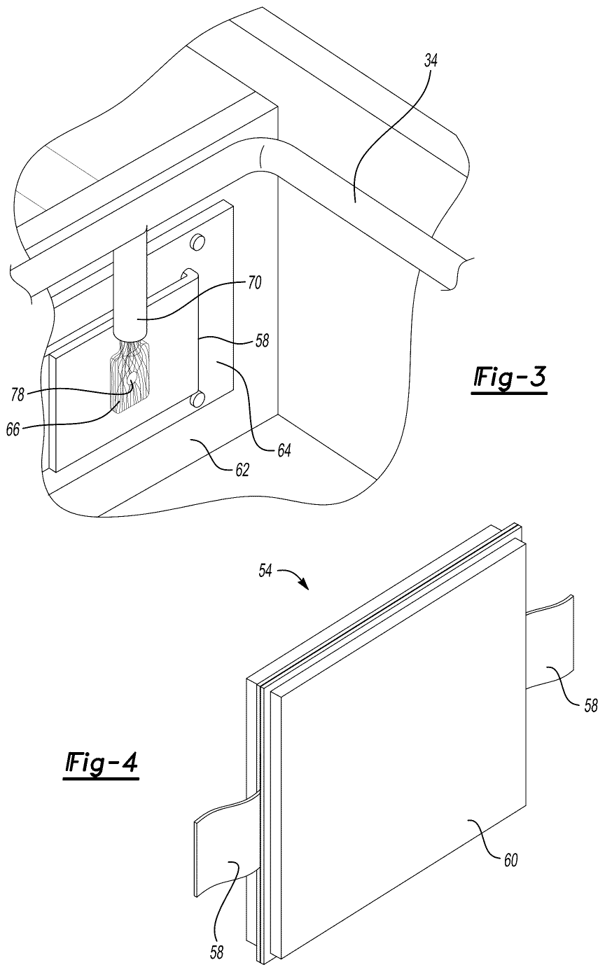

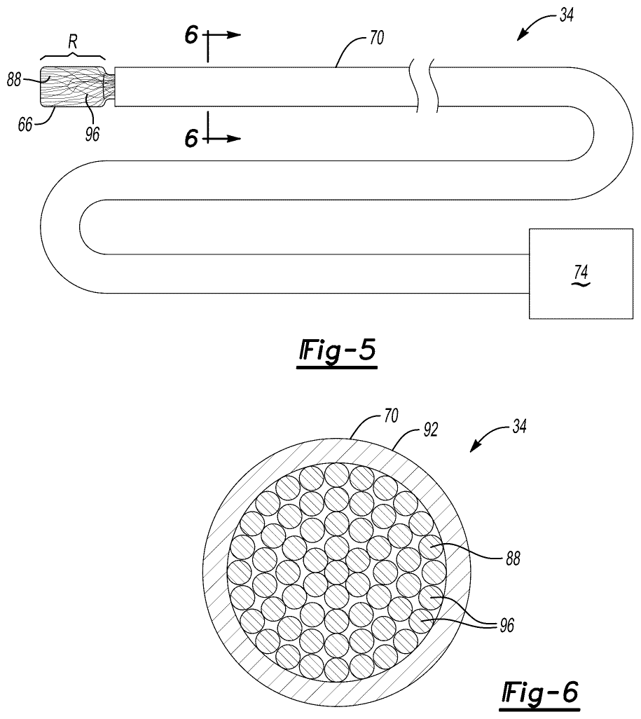

With reference now to FIGS. 5 and 6 and continuing reference to FIGS. 2 and 3, the example sensor assemblies 34 include a sensor tab 66, a sense lead 70, and a connector 74.

The sensor tab 66 is secured directly to a component of the battery pack 14—here the tab terminal 58. The sensor tab 66 can be secured to the tab terminal 58 with a weld, such as a laser weld 78. Welding the sensor tab 66 to the tab terminal 58 operatively couples the sensor tab 66 to the tab terminal 58 such that the sensor tab 66 can collect data from the tab terminal 58.

The sense lead 70 extends from the sensor tab 66 to the connector 74, which is connected to a connector 82 of one of the control modules 30. The connector 74 and the connector 82 can be plug-in pin-type connectors.

Data collected by the sensor tab 66 is communicated as a signal through the sense lead 70 and the connectors 74, 82 to the control module 30. The control module 30 can be a Battery Pack Sensor Module (BPSM). Data provided by the sensor assemblies 34 can be analyzed by the control module 30 to facilitate monitoring the battery pack 14. The control module 30 can identify issues based on data.

The sensor tab 66 and sense lead 70 are provided by a stranded wire 88. To establish the sensor tab 66, an insulative coating 92 is removed from a region R of the stranded wire 88, which exposes a plurality of individual conductive strands 96 of the stranded wire 88. These exposed individual conductive strands 96 are then compressed to provide the sensor tab 66.

In this example, the compression is an ultrasonic compression where the exposed individual conductive strands 96 within the region R are compressed within an ultrasonic welder. The ultrasonic compression of the exposed individual conductive strands 96 bonds together the exposed individual strands to provide the sensor tab 66. Other types of compression could be used in other examples.

The remaining portions of the stranded wire 88 remain attached to the sensor tab 66 and are not compressed. The remaining portions of the stranded wire 88 can remain uncompressed and bundled within the insulative coating 92 to provide the sense lead 70. Stranded wire is made up of a plurality of the individual strands 96 that are twisted together to form a larger conductor, which, among other things, enhances flexibility. A person having skill in this art would understand that stranded wire is different from solid wire.

Specifying that the sensor tab 66 is compressed, or ultrasonically compressed, structurally distinguishes the sensor tab 66 from other types of sensor tabs, such as sensor tabs that are cut from a solid sheet of material. A person having skill in this art and the benefit of this disclosure would be able to structurally distinguish a sensor tab that is established by compressing together a plurality of individual conductive strands from a sensor tab that is not compressed in this way. Thus, specifying that the sensor tab 66 is a compressed sensor tab structurally distinguishes the compressed sensor tab from other types of sensor tabs.

The connector 74 can be connected to an end of the stranded wire 88 opposite the sensor tab 66 to complete the sensor assembly 34. In the completed sensor assembly 34, stranded wire 88 extends from the connector 74 of the sense assembly 34 to the sensor tab 66 of the sense lead. The stranded wire 84 includes multiple individual strands 96.

Compressing a region of the stranded wire 88 to provide the sensor tab 66 can provide a relatively solid tab suitable for securing directly to the tab terminal 58 without leaving stray strands that could provide unwanted conductive paths. Further, as the sensor tab 66 is established by compressing the region of the stranded wire 88 without requiring the region to be separated, there is no need to secure a sense lead to the sensor tab 66 after ultrasonically compressing the region.

In the past, traces of flexible printed circuit boards were operatively coupled to tab terminals and other components for monitoring purposes. The sensor assemblies 34, which rely primarily on stranded wire, can be used in place of a flexible printed circuit board. As can be appreciated, this can reduce complexity.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a sensor tab configured to be secured to a component of a traction battery pack; and
a stranded wire having a compressed portion comprising the sensor tab and an uncompressed portion comprising a sense lead extending from the sensor tab.

2. The battery pack assembly of claim 1, wherein the sensor tab is an ultrasonically compressed sensor tab.

3. The battery pack assembly of claim 1, wherein the sensor tab is provided by ultrasonically compressed stranded wire.

4. The battery pack assembly of claim 1, wherein the sensor tab is secured to the component with at least one weld.

5. The battery pack assembly of claim 4, wherein the at least one weld is at least one laser weld.

6. The battery pack assembly of claim 1, wherein the component is a tab terminal of a battery cell.

7. The battery pack assembly of claim 1, further comprising a control module, the sense lead extending from the sensor tab to a connector that connects to the control module.

8. The battery pack assembly of claim 7, wherein the control module is a Battery Pack Sensor Module.

9. The battery pack assembly of claim 1, wherein the stranded wire providing the sense lead includes a plurality of individual strands.

10. A battery pack assembly comprising:
a cell stack including a plurality of battery cells disposed along a cell stack axis;
a compressed sensor tab attached to a portion of at least one of the battery cells within the plurality of battery cells; and
a stranded wire extending from the compressed sensor tab to a connector.

11. The battery pack assembly of claim 10, wherein the portion is a tab terminal of at least one of the battery cells within the plurality of battery cells.

12. The battery pack assembly of claim 11, wherein the compressed sensor tab is welded to at least one of the battery cells within the plurality of battery cells.

13. The battery pack assembly of claim 10, further comprising a connector, the stranded wire extending from the compressed sensor tab to the connector, the connector configured to engage a Battery Pack Sensor Module.

14. The battery pack assembly of claim 10, wherein the compressed sensor tab is provided by an ultrasonically compressed region of the stranded wire.

15. The battery pack assembly of claim 10, further comprising an insulative coating, the stranded wire including a plurality of individual conductive strands bundled within the insulative coating.

16. A battery pack sensor providing method, comprising:
sensing a parameter of a component within a traction battery pack through a sensor tab that is attached to the component, the sensor tab a compressed region of a stranded wire.

17. The battery pack sensor providing method of claim 16, further comprising attaching the sensor tab to the component by welding the sensor tab to the component.

18. The battery pack sensor providing method of claim 17, further comprising, prior to the sensing and the attaching, compressing a portion of the stranded wire to provide the compressed region of the stranded wire.

19. The battery pack sensor providing method of claim 18, wherein the compressing is an ultrasonic compressing.

20. The battery pack sensor providing method of claim 16, further comprising, during the sensing, communicating data from the sensor tab through the stranded wire to a control module of the traction battery pack.
